(19) United States
(12) Patent Application Publication
(10) Pub. No.: US 2012/0264904 A1
(43) Pub. Date: Oct. 18, 2012

(54) MANUFACTURING APPARATUS FOR DEODORING YARN AND ANUFACTURING METHOD FOR DEODORING YARN USING THE SAME

(76) Inventor: Tae Kyung KIM, Daejeon (KR)

(21) Appl. No.: 13/096,132

(22) Filed: Apr. 28, 2011

(30) Foreign Application Priority Data
Apr. 14, 2011 (KR) 10-2011-0034522

(51) Int. Cl. C08F 251/02; B01J 19/00

(52) U.S. Cl. 527/314; 422/138

(57) ABSTRACT

An apparatus and method for manufacturing a deodorizing yarn where a cellulose-based yarn is treated with a deodorizing solution by a graft polymerization reaction using steam heat in a reactor that is used in a conventional dyeing apparatus. The method for manufacturing the deodorizing yarn comprises the steps of: mixing a polymerization initiator, a deodorizing monomer and water to prepare a deodorizing solution; allowing the deodorizing solution to penetrate into bobbins, wound with a cellulose-based yarn, in a reactor; discharging the deodorizing solution from a reactor and dewatering the deodorizing solution that penetrated into the bobbins; supplying steam to the inside of the reactor so as to subject the cellulose-based yarn to thermal graft polymerization; water-washing the cellulose-based yarn that was subjected to the thermal graft polymerization; and drying the washed cellulose-based yarn at high temperature.

### CROSS REFERENCES

Applicant claims foreign priority under Paris Convention and 35 U.S.C. §119 to Korean Patent Application No. 10-2011-0034522, filed Apr. 14, 2011, with the Korean Intellectual Property Office, where the entire contents are incorporated herein by reference.

### BACKGROUND OF THE INVENTION

1. Field of the Invention

The present invention relates to an apparatus and method for manufacturing a deodorizing yarn, and more particularly to an apparatus and method for manufacturing a deodorizing yarn, in which a cellulose-based yarn is treated with a deodorizing solution by a graft polymerization reaction using steam heat in a reactor that is used in a conventional dyeing apparatus, whereby a deodorizing function can be imparted to the yarn without changing the wash durability and touch feeling of the yarn. 2. Description of the Prior Art

The human olfactory sense is very acute and plays an important role in human life. As the living standard has been improved, the smell of cigarette smoke, the smell of old people or the like which has not been considered a bad small is now recognized as a bad smell.

The kinds of smells that can be perceived by humans reach about 100,000. According to the current social trend toward cleanliness and etiquette, people who are aware of their own body odor while showing a sensitive response even to a little body odor are increasing.

Also, as the aging population increases each year, bad smells in the home, the increase in waste caused by the concentration of population to urban areas, and the resulting environmental pollution are also being recognized as objects to be deodorized. Although a variety of bad smells cannot be removed by deodorizing fibers alone, the social recognition of the deodorizing fibers has increased while the marketability of the deodorizing fibers in various fields has increased. In former days, four major offensive odors, including ammonia (NH₃), hydrogen sulfide (H₂S), trimethylamine ((CH₃)₃N) and methylmercaptan (CH₃SH) odors, were objects to be deodorized. Since then, deodorizing fibers against the smell of cigarette smoke were introduced, and in recent years, deodorizing fibers against the smells of humans, including the smell of sweat, have attracted attention.

There have been a number of attempts to impart a deodorizing function to fibers. Among these attempts, techniques of combining fibers with powdery deodorants, such as zeolite, activated carbon, charcoal, silica gel, active alumina, molecular sieves, and cyclodextrin, have been most frequently suggested. With respect to such techniques of combining fibers with powdery deodorants, Japanese Patent Laid-Open Publication No. Hei 2-307528 discloses a technique of combining a fiber with a powdery deodorant using a binder, and Japanese Patent Laid-Open Publication No. Hei 8-176338 discloses a technique of impregnating a powdery deodorant into absorbable resin particles. Also, Korean Patent Registration No. 473613 discloses a technique of incorporating chitosan, modified chitosan, a carboxylic acid polymer and zinc oxide into a binder resin.

In addition to the powdery deodorants, a number of liquid deodorants such as plant extracts have been suggested. However, when the binder is used to combine a fiber with a deodorant, there are disadvantages in that the touch feeling of the fiber is deteriorated and the deodorant is desorbed after long-term washing so that the deodorizing function of the fiber is deteriorated.

In recent years, techniques of imparting a deodorizing function to fibers using graft reactions by radiation have been suggested.

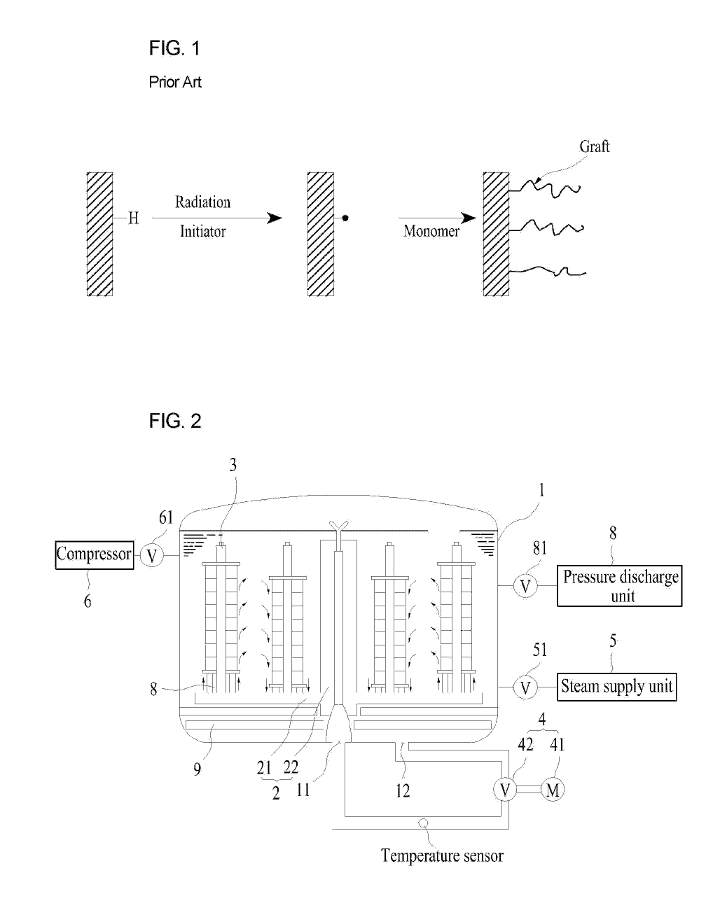

FIG. 1 illustrates a process of treating a fiber with a deodorizing solution by a graft polymerization reaction according to the prior art. As can be seen therein, a fiber base 100 is irradiated with radiation, and the radiation-irradiated fiber is immersed in a deodorizing solution containing a polymerization initiator, and the graft polymerization of the deodorizing solution on the fiber is carried out.

However, the prior-art process of treating the fiber with the deodorizing solution using radiation is applied to woven fabrics and has not been applied to general cotton yarns.

In addition, an apparatus of performing the graft polymerization of the deodorizing solution using radiation has a disadvantage in that it is very expensive, making it difficult for petty fiber processing companies to employ the apparatus.

### SUMMARY OF THE INVENTION

Accordingly, the present invention has been made in view of the above-described problems occurring in the prior art, and it is an object of the present invention to provide an apparatus and method for manufacturing a deodorizing yarn, in which a deodorizing solution is allowed to penetrate into bobbins, wound with a cellulose-based yarn, in a reactor which is used in a conventional dyeing apparatus, and a deodorizing function is imparted to the cellulose-based yarn by a graft polymerization reaction using steam heat.

To achieve the above object, in one aspect, the present invention provides an apparatus for manufacturing a deodorizing yarn, the apparatus comprising: a reactor in which an inlet for introducing a deodorizing solution consisting of a mixture of a deodorizing monomer, a polymerization initiator and water, and an outlet for discharging the deodorizing solution are provided at the lower end of the reactor; a deodorizing solution tank comprising a base placed above the deodorizing solution inlet so as to communicate with the deodorizing solution inlet, and a vertical hollow tube extending vertically from the central portion of the base so as to communicate with the inside of the base; a plurality of spindles placed vertically on the base so as to communicate with the inside of the base, each of the spindles consisting of a tube having a plurality of through-holes formed along the circumstance thereof, in which a plurality of bobbins wound with a cellulose-based yarn are stacked on the spindles; a deodorizing solution-circulating unit serving to circulate the deodorizing solution in the deodorizing solution tank and the reactor; a steam supply unit serving to supply steam to the inside of the reactor so as to subject the cellulose-based yarn to thermal graft polymerization; a compressor connected to the upper portion of the reactor and serving high-pressure air to the inside of the reactor; and a heat-exchange coil placed in the reactor and serving to heat or cool the inside of the reactor.

The apparatus of the present invention may further comprise a helical guide vane formed on the inner surface of each of the spindles between the through-holes, in which the guide vane serves to guide the deodorizing solution, introduced from the deodorizing solution tank, toward the upper portion of the spindles.

Also, the apparatus of the present invention may further comprise a plurality of ascending/descending means for ascending/descending each of the bobbin stacks, in which the ascending/descending means is provided on the base.

Also, the deodorizing solution may comprise 0.3-1.0 wt % of any one selected from among organic peroxide, ammonium peroxodisulfate, benzoyl peroxide and hydrogen peroxide as the polymerization initiator, 3-10 wt % of acrylic acid or neutralized acrylic acid as the deodorizing monomer, and the balance of water.

In another aspect, the present invention provides a method for manufacturing a deodorizing yarn, the method comprising the steps of: mixing a polymerization initiator, a deodorizing monomer and water to prepare a deodorizing solution; allowing the deodorizing solution to penetrate into bobbins, wound with a cellulose-based yarn, in a reactor; discharging the deodorizing solution from the reactor and dewatering the deodorizing solution that penetrated into the bobbins; supplying steam to the inside of the reactor so as to subject the cellulose-based yarn to thermal graft polymerization; water-washing the cellulose-based yarn that was subjected to the thermal graft polymerization; and drying the washed cellulose-based yarn at high temperature.

In the method of the present invention, the thermal graft polymerization may be carried out at 100-150° C. for 10-30 minutes, and the washing step may be carried out at 90-100° C. for 20-40 minutes.

### BRIEF DESCRIPTION OF THE INVENTION

The above and other objects, features and advantages of the present invention will be more clearly understood from the following detailed description taken in conjunction with the accompanying drawing, in which:

FIG. 1 illustrates a process of treating a fiber with a deodorizing solution using a graft reaction according to the prior art;

FIG. 2 shows the configuration of an apparatus for manufacturing a deodorizing yarn according to the present invention;

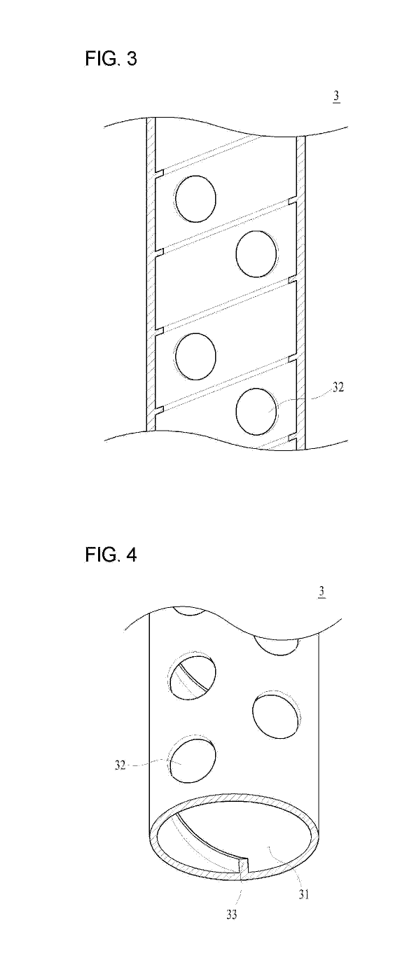

FIG. 3 is a partial perspective view of the spindle shown in FIG. 2;

FIG. 4 is a partial cross-sectional view of the spindle shown in FIG. 2;

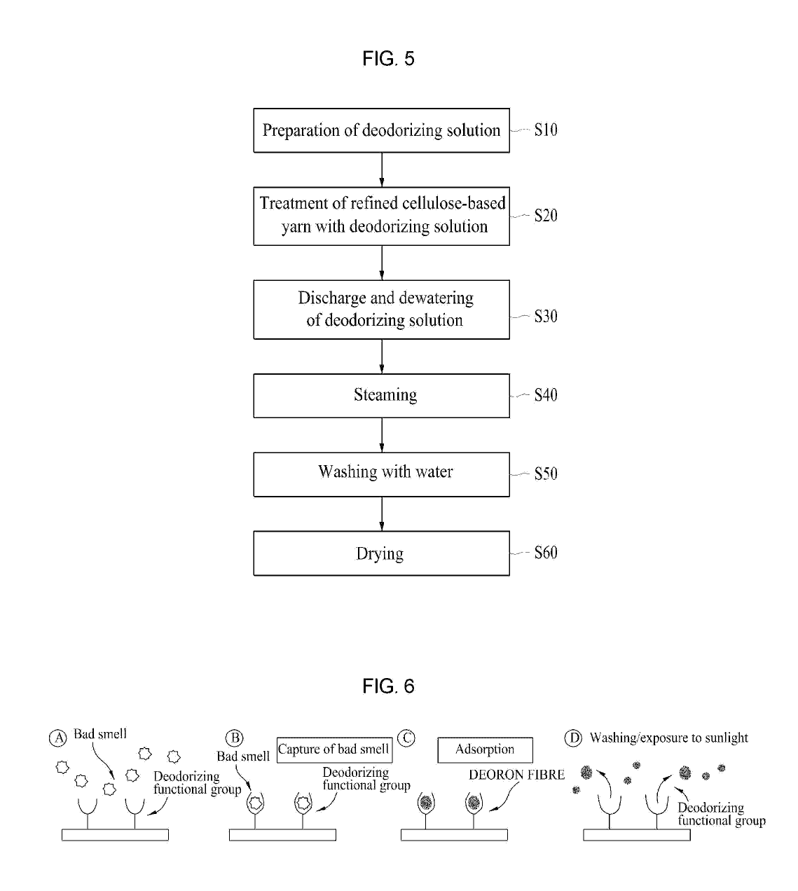

FIG. 5 is a process flow chart showing a method for manufacturing a deodorizing yarn according to the present invention;

FIG. 6 shows the principle by which a cellulose-based yarn treated with a deodorizing solution using a thermal graft polymerization reaction according to the present invention removes a bad smell; and

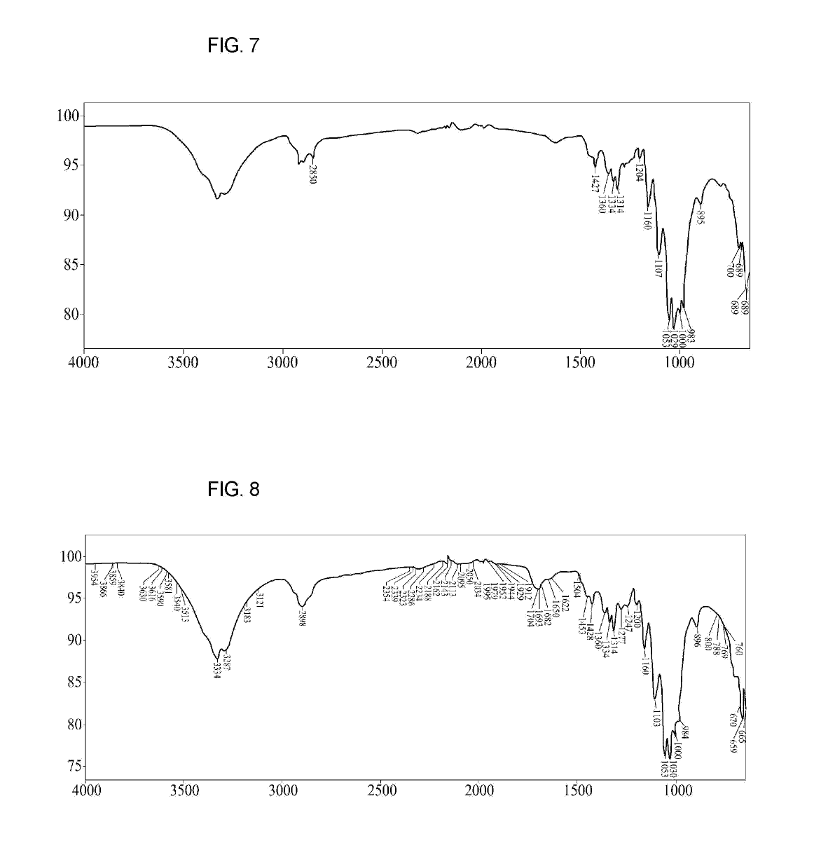

FIGS. 7 and 8 are graphs showing FT-IR spectra measured in order to examine the degree of reaction of a deodorizing monomer on a sample treated with a deodorizing solution according to Test Example 1 of the present invention.

### DETAILED DESCRIPTION OF THE INVENTION

Hereinafter, a preferred embodiment of the present invention will be described in detail with reference to the accompanying drawings.

FIG. 2 shows the configuration of an apparatus for manufacturing a deodorizing yarn according to the present invention, FIG. 3 is a partial perspective view of the spindle shown in FIG. 2, and FIG. 4 is a partial cross-sectional view of the spindle shown in FIG. 2.

Referring to FIGS. 2 to 4, the inventive apparatus for treating a cellulose-based yarn with a deodorizing solution comprises a reactor 1, a deodorizing solution tank 2, a plurality of spindles 3, a deodorizing solution-circulating unit 4, a steam supply unit 5, a compressor 6 and a heat-exchange coil 7.

The reactor 1 is composed of a body having a space formed therein, and a deodorizing solution inlet 11 and a deodorizing solution outlet 12 are provided at the lower end of the reactor 1. The deodorizing solution is a mixture of a deodorizing monomer, a polymerization initiator and water. Specifically, the deodorizing solution comprises 0.3-1.0 wt % of ammonium peroxodisulfate as the polymerization initiator, 3-10 wt % of acrylic acid or neutralized acrylic acid as the deodorizing monomer, and the balance of water.

The deodorizing solution tank 2 is placed above the deodorizing solution inlet in the reactor 1 in such a manner as to communicate with the deodorizing solution inlet 11 and serves to store the deodorizing solution introduced from the deodorizing solution inlet 11. It comprises a base 21 and a vertical hollow tube 22. The base 21 is made of a sheet material and has a space formed therein so as to communicate with the deodorizing solution inlet 11, and it is placed horizontally above the deodorizing solution inlet 11. Also, the vertical hollow tube 22 is made of a tube and has a hollow portion formed so as to communicate with a base 21, and it extends upward from the central portion of the base 21.

The plurality of spindles 3 are each made of a tube comprising a hollow portion 31 and a plurality of through-holes formed along the circumstance of the tube. The spindles 3 are vertically placed at a certain distance from each other so as to communicate with the inside of the base 21. Also, on each of the spindles 3, a plurality of bobbins “B” wound with a cellulose-based yarn are stacked. Also, a helical guide vane 33 is formed on the inner surface of the spindle 3 between the through-holes 32. The guide vane 33 serves to guide the deodorizing solution, introduced into the lower portion of the spindle 3, toward the upper portion of the spindle, so that the deodorizing solution is uniformly discharged and the spray pressure of the deodorizing solution is increased. Namely, the deodorizing solution introduced into the spindle 3 is discharged from the spindle 3 through the through-holes 32, in which the deodorizing solution is smoothly discharged at the lower portion of the spindle due to high pressure, whereas the deodorizing solution is not smoothly discharged at the upper portion of the spindle, because the pressure decreases toward the upper end. Thus, the amount of deodorizing solution supplied is different between the bobbins “B” located at the upper and lower portions of the spindle 3, so that the deodorizing performance is different between the upper and lower portions of the spindle 3. To overcome this problem, according to the present invention, the guide vane 33 that guides the deodorizing solution, introduced into the lower end of the spindle 3, to the upper portion of the spindle 3, is formed so that the bobbins “B” located at the upper and lower portions of the spindles 3 can be uniformly treated with the deodorizing solution. Also, because the deodorizing solution that is sprayed through the through-holes 32 is discharged from the spindle 3 while it is rotated by the guide vane 33 in the spindle 3, the spray pressure of the deodorizing solution increases due to the rotating force, and the bombardment of the deodorizing solution toward the bobbins “B” is facilitated due to the increase in the spray pressure, so that the penetration of the deodorizing solution into the bobbins “B” is facilitated.

Meanwhile, the deodorizing solution-circulating unit 4 serves to allow the deodorizing solution to circulate in the deodorizing solution tank 2 and the reactor 1, and it comprises a deodorizing solution-circulating pump 41 and a directional control valve 42. Namely, using the directional control valve 42, the deodorizing solution inlet 11 is open, and the deodorizing solution outlet 12 is closed. In this state, the deodorizing solution-circulating pump 41 is driven. Then, the deodorizing solution is sent to the deodorizing solution tank 2, after which it flows upward along the plurality of spindles 3 while it is discharged at high pressure into the reactor 1 through the through-holes formed along the circumstance of the spindles 3, and the high-pressure deodorizing solution thus discharged penetrates into the cellulose-based yarn wound around the bobbins “B”. On the contrary, if the deodorizing solution is charged in the reactor 1, the directional control valve 42 is used to open the deodorizing solution inlet 11 and close the deodorizing, solution outlet 12, so that the deodorizing solution in the reactor can be discharged.

Also, the steam supply unit 5 is connected to the lower end of the reactor 1 and serves to supply steam to the inside of the reactor 1 so that the cellulose-based yarn treated with the deodorizing solution is steamed. Thus, the thermal graft polymerization of the deodorizing monomer on the cellulose-based yarn occurs, so that the cellulose-based yarn has a deodorizing property. Between the reactor 1 and the steam supply unit 5, a steam control valve 51 for controlling the supply of steam is provided.

The compressor 6 is connected to the upper portion of the reactor 1, and it serves to supply high-pressure air to the inside of the reactor 1 to pressurize the reactor 1, whereby the discharge of the deodorizing solution from the reactor, and the removal of water from the deodorizing solution that penetrated into the cellulose-based yarn can be easily achieved. Between the reactor 1 and the compressor 6, a high-pressure air control valve for controlling the supply of high-pressure air is provided.

Meanwhile, the heat-exchange coil 7 is placed at the lower portion of the inside of the reactor 1 and serves to heat or cool the inside of the reactor 1. Specifically, it functions to heat the inside of the reactor 1 during the steaming or washing process.

Meanwhile, on the base 21, a plurality of ascending/descending means such as cylinders, which serve to ascend and descend the bobbin stacks, may further be provided. Namely, these means serve to ascend any one of the adjacent stacks of the bobbins “B” and descend the other bovine stack, so that strong vortical flow can be formed between the stacks of the bobbins “B” to increase the penetration of the deodorizing solution into the bobbins.

In addition, the apparatus of the present invention may further comprise a pressure discharge unit 8 which is connected to the reactor 1, wherein the pressure discharge unit serves to reduce the internal pressure of the reactor 1 if the internal pressure of the reactor 1 increases. Between the pressure discharge unit 8 and the reactor 1, a pressure discharge control valve 81 may be provided.

FIG. 5 is a process flowchart showing a method for manufacturing a deodorizing yarn according to the present invention. Hereinafter, the inventive method for manufacturing a deodorizing yarn will be described in detail with reference to FIGS. 2 to 5.

First, the bobbins “B” wound with a refined cellulose-based yarn are stacked on the spindles 3. In general, because natural cellulose fibers contain a large amount of impurities which reduce the contact area between the cellulose and the deodorizing solution, components such as oils and fats should be removed with a refining agent so that the reactivity of the water-soluble deodorizing solution with the yarn can be increased. For this reason, a refined cellulose-based yarn is preferably used.

Then, 0.3-1.0 wt % of a polymerization initiator, 3-10 wt % of a deodorizing monomer and the balance of water are mixed with each other to prepare a deodorizing solution (S10). In this regard, the polymerization initiator is preferably an organic peroxide initiator, particularly ammonium peroxodisulfate, benzoyl peroxide or hydrogen peroxide, rather than a radical polymerization initiator. Also, the content of the polymerization initiator in the deodorizing solution has an effect on the graft polymerization reaction of the monomer, and thus is preferably adjusted within the range of 0.3-1.0 wt %. If the content of the polymerization initiator is less than 0.3 wt %, it cannot sufficiently initiate the graft polymerization reaction, and a polymerization initiator content of more than 0.0 wt % will be cost-ineffective. For this reason, the content of the polymerization initiator is adjusted within the range of 0.3-1.0 wt %.

Also, the deodorizing monomer that is used in the present invention may be an acrylic or vinyl monomer containing a carboxylic acid group, a sulfonic acid group or an amino group, which neutralizes bad smells using an ion exchange property. If the deodorizing monomer is used in an amount of less than 3 wt %, it will have little or no deodorizing ability, and if it is used in an amount of more than 10 wt %, an excessive amount of the monomer will not be polymerized and will remain on the fabric. For this reason, the deodorizing monomer is preferably used in an amount of 3-10 wt %.

Next, the deodorizing solution is sprayed at high pressure onto the stacked bobbins “B” to treat the cellulose-based yarn with the deodorizing solution (S20). Specifically, the directional control valve 42 is controlled to open the deodorizing solution inlet 11, and the deodorizing solution-circulating pump 41 is driven so that the prepared deodorizing solution is sent to the deodorizing solution tank 2. The deodorizing solution sent to the tank 2 is introduced under pressure into each of the spindles 3, and the introduced deodorizing solution is sprayed at high pressure into the reactor 1 through the through-holes 32. The sprayed deodorizing solution penetrates into the bobbins “B”, and thus the cellulose-based yarn is wet with the deodorizing solution.

Then, the deodorizing solution in the reactor 1 is discharged, and the deodorizing solution that penetrated into the bobbins “B” is dewatered (S30). Specifically, the directional control valve 42 is controlled to open the deodorizing solution outlet 12, and high-pressure air is supplied to the inside of the reactor 1 using the compressor 6. Accordingly, the deodorizing solution in the reactor 1 is discharged through the deodorizing solution outlet 12, and the deodorizing solution that penetrated into the bobbins “B” is dewatered by high pressure.

Then, steam produced in the steam supply unit 5 is supplied to the inside of the reactor 1 so that the cellulose-based yarn is steamed (S40). In the steaming process, the heat-exchange coil 7 is heated so that the internal temperature of the reactor is increased to 100-150° C. and maintained at that temperature for 10-30 minutes. When the cellulose-based yarn is steamed as described above, the thermal graft polymerization of the deodorizing monomer attached to the cellulose-based yarn will occur, thus obtaining a deodorizing cellulose-based yarn that has good wash durability and gives good touch feeling.

Next, the steam in the reactor 1 is discharged using the pressure discharge unit 8, after which the cellulose-based yarn is washed with water (S50). In this regard, the water-washing process is carried out at 90˜100° C. for 20-40 minutes.

Then, the bobbins “B” wound with the cellulose-based yarn are taken out of the reactor and dried at high temperature using hot air (S60).

FIG. 6 shows the principle by which the cellulose-based yarn treated with the deodorizing solution by the thermal graft reaction according to the present invention removes bad smells. As can be seen therein, a deodorizing functional group formed on the cellulose-based yarn captures bad smells, and the captured bad smell components are adsorbed onto the deodorizing functional group. When the yarn is washed and dried, the bad smell components adsorbed onto the deodorizing functional groups are volatilized.

As described above, according to the present invention, by treating the fiber with the deodorizing solution by thermal graft polymerization using steam heat, the graft polymerization reaction can efficiently occur in the inside and outside of the bobbins. Namely, unlike the present invention, if the deodorizing solution charged in the reactor is subjected to graft polymerization by heating the inside of the reactor, the hydroxyl (OH) group of the deodorizing monomer will react more with water than the cellulose-based yarn, indicating that the polymerization efficiency of the monomer is low. Also, unlike the present invention, if the graft polymerization of the deodorizing monomer is carried out by heating the inside of the reactor in a state in which the deodorizing solution was dewatered, the outside of the bobbin will be in a dry state, and the inside of the bobbin will have high humidity, so that the graft polymerization of the monomer will differ between the inside and the outside of the bobbin, and thus the deodorizing function of the yarn will be non-uniform. On the other hand, according to the present invention, the internal humidity and temperature of the reactor are maintained uniformly using steam heat, whereby uniform graft polymerization of the deodorizing monomer occurs in the inside and the outside of the bobbin, and the hydroxyl (OH) group of the monomer does not react with external water, and thus the efficiency of the graft polymerization of the deodorizing monomer on the cellulose-based yarn will be improved.

Hereinafter, the method for manufacturing the deodorizing yarn according to the present invention will be described with reference to test examples.

### TEST EXAMPLE 1

First, 250 g of acrylic acid as a deodorizing monomer, 75 g of ammonium peroxodisulfate as a polymerization initiator, and 4,675 g of water were mixed with each other to prepare a deodorizing solution. Also, 1.3 kg of a refined cotton yarn together with the deodorizing solution was placed in a 3-kg scale reactor 1, and the internal temperature of the reactor was increased to 110° C. In order to maintain the internal temperature and temperature of the reactor 1 uniformly, saturated steam having a temperature of 110° C. was injected from a steam supply unit 5 into the reactor 1, and the deodorizing solution was subjected to a thermal graft reaction in the reactor 1 for 30 minutes. Then, the steam in the reactor 1 was discharged, after which the cotton yarn was washed with water in the reactor 1 at 95° C. for 20 minutes, and the washed cotton yarn was taken out of the reactor and dried with hot air.

FIGS. 7 and 8 are graphs showing FT-IR spectra measured in order to examine the degree of reaction of the deodorizing monomer on the sample treated with the deodorizing solution according to Test Example 1 of the present invention. Specifically, FIG. 7 is the FT-IR spectrum of the sample, measured before treatment with the deodorizing solution is carried out, and FIG. 8 is the FT-IR spectrum of the sample, measured after treatment with the deodorizing solution has been carried out.

As shown in FIGS. 7 and 8 and Table 1 below, before treatment with the deodorizing solution, the carbonyl (C=0) peak of carboxylic acid did not appear, but after treatment with the deodorizing solution, the carbonyl (C═O) peak of carboxylic acid appeared at 1720-1740 cm⁻¹, indicating that acrylic acid reacted with the cotton.

TABLE 1

| Treatment with deodorizing solution | Carbonyl (C═O) peak |
|---|---|
| Carried out | Appeared |
| Not carried out | Not appeared |

### TEST EXAMPLE 2

Test Example 2 was carried out in the same manner as Example 1, except that acrylic acid neutralized to a pH of 4.5-5.5 was used as the deodorizing monomer.

Table 2 below shows the results obtained by adding 1-7 ml of 1000 ppm ammonia solution dropwise into a bottle containing 5 g of the cotton yarn treated with the deodorizing solution and 100 ml of distilled water and measuring the pH of the content of the bottle 5 minutes after the addition of the ammonia solution. As can be seen in Table 2, when the ammonia solution was added to the bottle containing the cotton yarn treated with the deodorizing solution, there was little or no change in the pH of the cotton yarn, indicating that the neutralized acrylic acid reacted with the cotton.

TABLE 2

| Amount (ml) of NH₃ | 0 | 1 | 2 | 3 | 4 | 5 | 6 | 7 |
|---|---|---|---|---|---|---|---|---|
| Before treatment with | 7.2 | 9.6 | 9.9 | 10.1 | 10.2 | 10.3 | 10.4 | 10.4 |
| deodorizing solution | | | | | | | | |
| treatment with | 7.2 | 6.8 | 6.8 | 6.9 | 6.9 | 7.0 | 7.1 | 7.1 |
| deodorizing solution | | | | | | | | |

Table 3 below shows the results obtained by adding 1-7 ml of 1000 ppm acetic acid solution dropwise into a bottle containing 5 g of the cotton yarn treated with the deodorizing solution and 100 ml of distilled water and measuring the pH of the content of the bottle 5 minutes after the addition of the acetic acid solution. As can be seen in Table 3, when the acetic acid solution was added to the bottle containing the cotton yarn treated with the deodorizing solution, there was little or no change in the pH of the cotton yarn, indicating that the neutralized acrylic acid reacted with the cotton.

TABLE 3

| Amount (ml) of acetic acid | 0 | 1 | 2 | 3 | 4 | 5 | 6 | 7 |
|---|---|---|---|---|---|---|---|---|
| Before treatment with | 7.1 | 6.8 | 6.5 | 6.2 | 5.9 | 5.7 | 5.5 | 5.3 |
| deodorizing solution | | | | | | | | |
| treatment with | 6.8 | 6.6 | 6.5 | 6.4 | 6.4 | 6.3 | 6.3 | 6.2 |
| deodorizing solution | | | | | | | | |

### TEST EXAMPLE 3

In Test Example 3, the degree of reaction of the deodorizing monomer according to the concentration of the polymerization initiator was measured. Specifically, while the concentration of the polymerization initiator in the deodorizing solution in Test Example 1 was changed, whether the graft polymerization of the deodorizing monomer occurred was observed. As a result, as can be seen in Table 4 below, when the concentration of the polymerization initiator reached 0.3 wt % or more, the thermal graft polymerization of the deodorizing monomer occurred.

TABLE 4

| Concentration (wt %) | Carbonyl (C═O) peak | Touch feeling |
|---|---|---|
| 0.1 | Did not appear | Good |
| 0.3 | Appeared | Good |
| 0.5 | Appeared | Good |
| 0.7 | Appeared | Good |

### TEST EXAMPLE 4

In Test Example 4, the degree of reaction of the deodorizing monomer according to the concentration of the deodorizing monomer was measured. Specifically, while the concentration of the deodorizing monomer in the deodorizing solution in Test Example 1 was changed, whether the graft polymerization of the deodorizing monomer occurred was observed. As a result, as can be seen in Table 5 below, when the concentration of the deodorizing monomer reached 3 wt % or more, the carbonyl (C═O) peak appeared, indicating that the graft polymerization of the deodorizing monomer occurred.

TABLE 5

| Concentration (wt %) | Carbonyl (C═O) peak | Touch feeling |
|---|---|---|
| 1 | Did not appear | Good |
| 3 | Appeared | Good |
| 5 | Appeared | Good |
| 7 | Appeared | Moderate |
| 10 | Appeared | Moderate |

### TEST EXAMPLE 5

In Test Example 5, the degree of reaction of the deodorizing monomer according to the temperature of steam was measured. In Test Example 5, the process of treatment with the deodorizing solution was carried out under the same conditions as those in Test Example 1, except that the temperature of steam was changed. After treatment with the deodorizing solution, the sample was steamed for 30 minutes at each of various temperatures and washed with water, after which the degree of reaction of the deodorizing monomer was observed. As a result, as can be seen in Table 6 below, when the steaming temperature reached 100° C. or higher, the carbonyl (C═O) peak appeared, indicating that the graft polymerization reaction of the deodorizing monomer occurred.

TABLE 6

| Temperature (° C.) | Carbonyl (C═O) peak | Touch feeling |
|---|---|---|
| 95 | Did not appear | Good |
| 100 | Appeared | Good |
| 105 | Appeared | Good |
| 110 | Appeared | Good |
| 120 | Appeared | Good |

As described above, according to the present invention, the deodorizing solution is allowed to penetrate into the bobbins wound with the cellulose-based yarn, and the graft polymerization of the deodorizing monomer on the cellulose-based yarn is carried out using steam heat, thus imparting a deodorizing function to the cellulose-based yarn. By doing so, the deodorizing function can be imparted to the yarn without changing the wash durability and touch feeling of the yarn.

Also, in the present invention, a general dyeing apparatus is used without using an expensive radiation graft polymerization apparatus, and thus equipment and production costs can be reduced.

In addition, according to the present invention, the process of treatment with the deodorizing solution is carried out using a thermal graft polymerization reaction by steam heat. By doing so, a more uniform and efficient graft polymerization reaction can occur in the inside and outside of the bobbin, unlike either the case of heating the inside of the reactor in a state in which the deodorizing solution was immersed in the reactor, or the case of heating the inside of the reactor in a state in which the deodorizing solution was dewatered.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for manufacturing a deodorizing yarn, the apparatus comprising:
a reactor in which an inlet for introducing a deodorizing solution consisting of a mixture of a deodorizing monomer, a polymerization initiator and water, and an outlet for discharging the deodorizing solution are provided at the lower end of the reactor;
a deodorizing solution tank comprising a base placed above the deodorizing solution inlet so as to communicate with the deodorizing solution inlet, and a vertical hollow tube extending vertically from the central portion of the base so as to communicate with the inside of the base;
a plurality of spindles placed vertically on the base so as to communicate with the inside of the base, each of the spindles consisting of a tube having a plurality of through-holes formed along the circumstance thereof, in which a plurality of bobbins wound with a cellulose-based yarn are stacked on the spindles;
a deodorizing solution-circulating unit serving to circulate the deodorizing solution in the deodorizing solution tank and the reactor;
a steam supply unit serving to supply steam to the inside of the reactor so as to subject the cellulose-based yarn to thermal graft polymerization;
a compressor connected to the upper portion of the reactor and serving high-pressure air to the inside of the reactor; and
a heat-exchange coil placed in the reactor and serving to heat or cool the inside of the reactor.

2. The apparatus of claim 1, further comprising a helical guide vane formed on the inner surface of each of the spindles between the through-holes, in which the guide vane serves to guide the deodorizing solution, introduced from the deodorizing solution tank, toward the upper portion of the spindles.

3. The apparatus of claim 1, comprising a plurality of ascending/descending means for ascending/descending each of the bobbin stacks, in which the ascending/descending means is provided on the base.

4. The apparatus of claim 1, wherein the deodorizing solution may comprise 0.3-1.0 wt % of any one initiator selected from among organic peroxide, ammonium peroxodisulfate, benzoyl peroxide and hydrogen peroxide as the polymerization initiator, 3-10 wt % of acrylic acid or neutralized acrylic acid as the deodorizing monomer, and a balance of water.

5. A method for manufacturing a deodorizing yarn, the method comprising the steps of:
mixing a polymerization initiator, a deodorizing monomer and water to prepare a deodorizing solution; allowing the deodorizing solution to penetrate into bobbins, wound with a cellulose-based yarn, in a reactor;
discharging the deodorizing solution from the reactor and dewatering the deodorizing solution that penetrated into the bobbins;
supplying steam to the inside of the reactor so as to subject the cellulose-based yarn to thermal graft polymerization;
water-washing the cellulose-based yarn that was subjected to the thermal graft polymerization; and
drying the washed cellulose-based yarn at high temperature.

6. The method of claim 5, wherein the deodorizing solution comprises 0.3-1.0 wt % of ammonium peroxodisulfate as the polymerization initiator, 3-10 wt % of acrylic acid or neutralized acrylic acid as the deodorizing monomer, and a balance of water.

7. The method of claim 5, wherein the thermal graft polymerization is carried out at 100˜150° C. for 10-30 minutes, and the washing step is carried out at 90˜100° C. for 20-40 minutes.
